(19) United States
(12) Patent Application Publication
(10) Pub. No.: US 2024/0349868 A1
(43) Pub. Date: Oct. 24, 2024

(54) Refillable Cosmetic Pump Package

(71) Applicant: Fusion Packaging I, LLC, Dallas, TX (US)

(72) Inventors: Alexander Lee Kwapis, Dallas, TX (US); Alex Moskvin, Port Jefferson Station, NJ (US); Nils Ernst Alfons Siegel, New York, NY (US)

(21) Appl. No.: 18/292,335

(22) PCT Filed: Jul. 26, 2022
(86) PCT No.: PCT/US22/38396

§ 371 Date: Jan. 25, 2024

Related U.S. Application Data
(60) Provisional application No. 63/225,760, filed on Jul. 26, 2021.

(51) Int. Cl. A45D 34/00

(52) U.S. Cl. CPC A45D 34/00; A45D 2034/005; A45D 2200/055

(57) ABSTRACT

A cosmetic apparatus, comprising: (i) a first member, comprising a body, an actuator at a first end of the body, and an aperture at a second end of the body, distal from the first end; and (ii) a second member comprising a pump, a storage volume, the storage volume configured to store cosmetic, and an engaging member for fitting the second member at least partially through the aperture and at least partially within the body.

### TECHNICAL FIELD

The preferred embodiments relate to a refillable cosmetic pump package.

### BACKGROUND ART

There are generally two types of conventional dispensers of cosmetic product. A first type has a dip tube type that draws product while an equivalent volume of air is pulled in to the container as the product is evacuated. The other type is an airless system with a piston in the bottle behind (e.g., below) the product and the piston advances toward the pump (e.g., ascends) while the product is sucked up and dispensed by the pump. Air fills the vacuum behind the piston to maintain equilibrium inside the bottle without touching the product. This system avoids the mix of air and product as part of the dispensing system.

In some prior art cosmetic dispensers, a consumer (user) is able to refill cosmetic into the product. Such approaches may include numerous user-removable pieces, for example as an actuator from the top of the package, and a refillable bottle from the top of the package. Prior art approaches also may have the user re-use the package pumping mechanism, for example as part of the refillable product.

While the preceding has been implemented in the prior art, such approaches may provide certain drawbacks. Example embodiments are provided below, which may improve upon such drawbacks.

### DISCLOSURE OF INVENTION

In one example, there is a cosmetic apparatus, comprising: (i) a first member, comprising a body, an actuator at a first end of the body, and an aperture at a second end of the body, distal from the first end; and (ii) a second member comprising a pump, a storage volume, the storage volume configured to store cosmetic, and an engaging member for fitting the second member at least partially through the aperture and at least partially within the body.

Other aspects are described and claimed.

### BRIEF DESCRIPTION OF DRAWINGS

FIG. 1A is an exploded view of a refillable cosmetic pump package 100.

FIG. 1B is an assembled view of the FIG. 1A package.

FIG. 2A illustrates the FIG. 1A-1B outer bottle assembly 104 and the overcap 102 in perspective view.

FIG. 2B illustrates the FIG. 1A-1B outer bottle assembly 104 and the overcap 102 in side view.

FIG. 2C illustrates the FIG. 1A-1B outer bottle assembly 104 and the overcap 102 in cross-sectional view.

FIG. 3A illustrates the FIGS. 1A-1B inner bottle assembly 106 in side view.

FIG. 3B illustrates the FIGS. 1A-1B inner bottle assembly 106 in cross-sectional view.

FIG. 3C illustrates the FIGS. 1A-1B inner bottle assembly 106 in perspective view.

FIG. 4 illustrates a perspective view of the inner bottle assembly 106 when coupled to the outer bottle assembly.

FIG. 5 illustrates an axially cross sectional view of FIG. 1B.

FIGS. 6A-6C illustrate the disassembly steps of removing the outer bottle assembly 104 from the inner bottle assembly 106.

FIGS. 6D-6G illustrate the assembly steps of attaching the outer bottle assembly 104 to the inner bottle assembly 106.

FIG. 7 illustrates an alternative example of the FIGS. 1A-1B inner bottle assembly 106 in cross-sectional view, in which is a bellow spring is incorporated into the pump 134.

### DESCRIPTION OF EMBODIMENTS

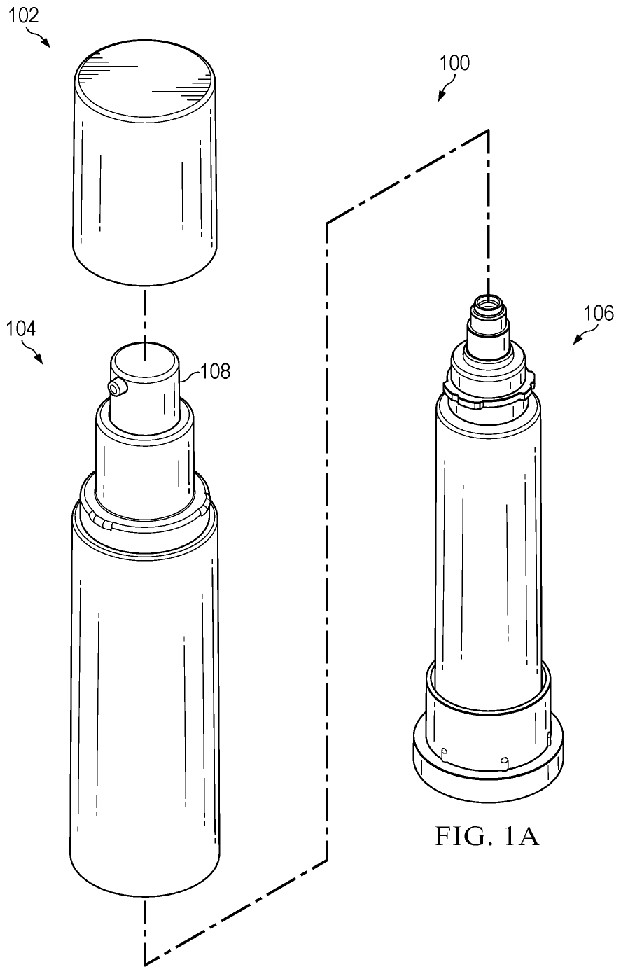

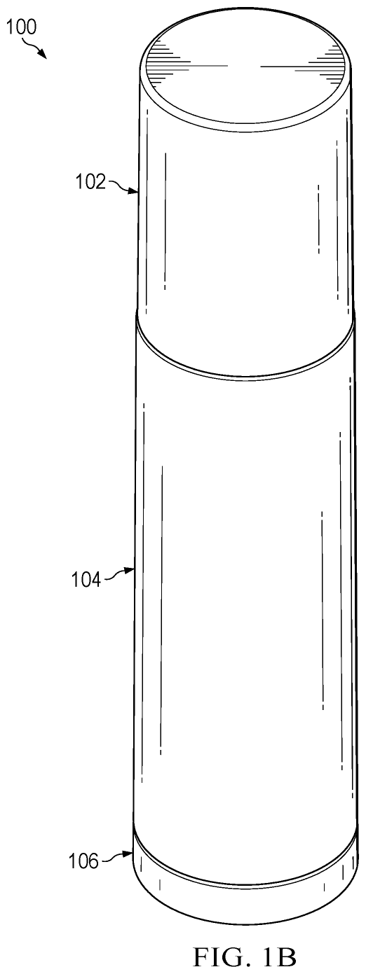

FIG. 1A is an exploded view of a refillable cosmetic pump package 100. In an example embodiment, the package 100 includes the following items: an overcap 102, an outer bottle assembly 104, and an inner bottle assembly 106, where a fluid cosmetic is stored in the inner bottle assembly 106 and when that assembly is fitted to the outer bottle assembly 104, the cosmetic may pass to and be dispensed from the outer bottle assembly 104. In certain respects, these items may be fabricated from various materials, into various shapes and dimensions, and further per the skill in the art given the present document teachings. For example, the overcap 102 and the outer bottle assembly 104 may be formed from polyethylene terephthalate (PET), either from extruded or molding processes, while the inner bottle assembly 106 may be formed from polypropylene (PP), a thermoplastic made from the combination of propylene monomers and that is readily recyclable. The use of separate materials may facilitate different recycling selections for the different materials. As another example, the entirety of the overcap 102, the outer bottle assembly 104, and the inner bottle assembly 106 may be formed from a same recyclable material, for example as PP. Further, known or developed molding (including 3d printing) techniques may be used to form each item, so as to have the desired shape and physical fitment, cooperation, and relationship described herein. Except where otherwise indicated as required or potentially preferred, the various items may fit together by snap or friction fit, with or without adhesive, and also permitting movable relationships as also described herein.

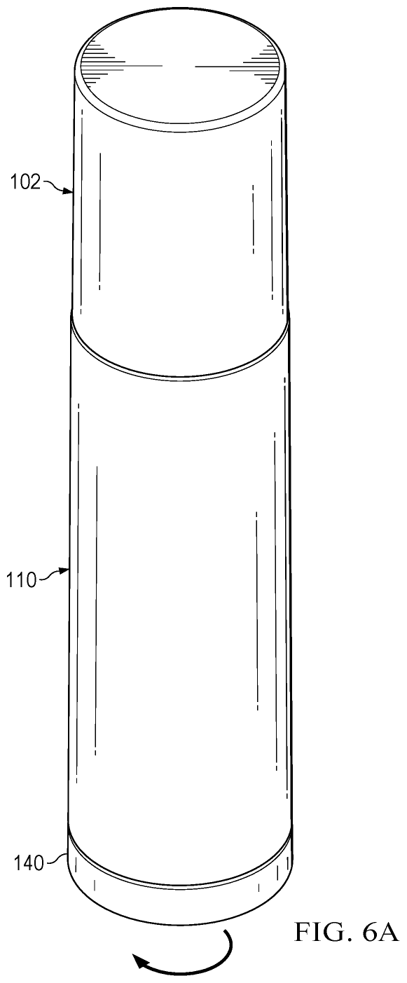

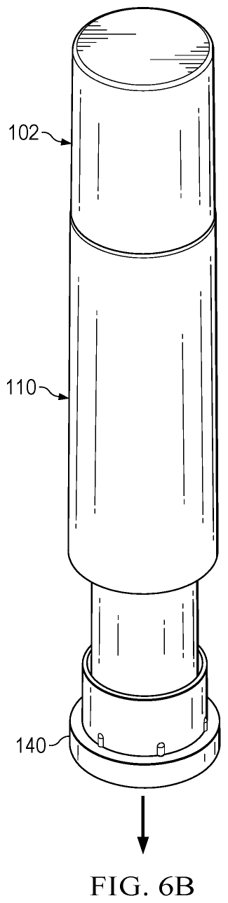

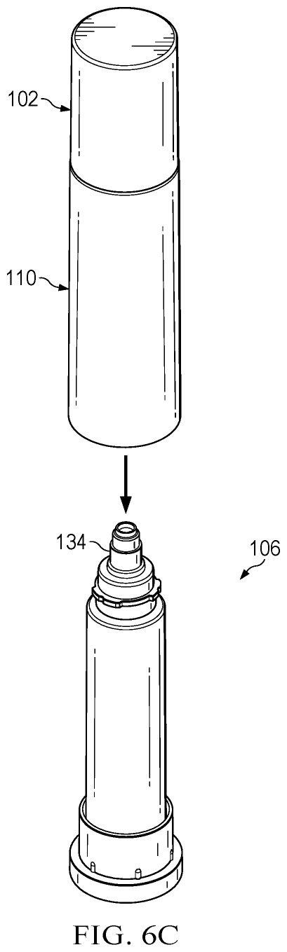

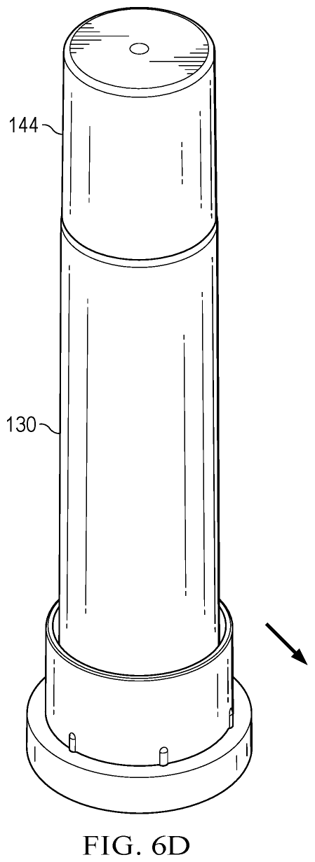

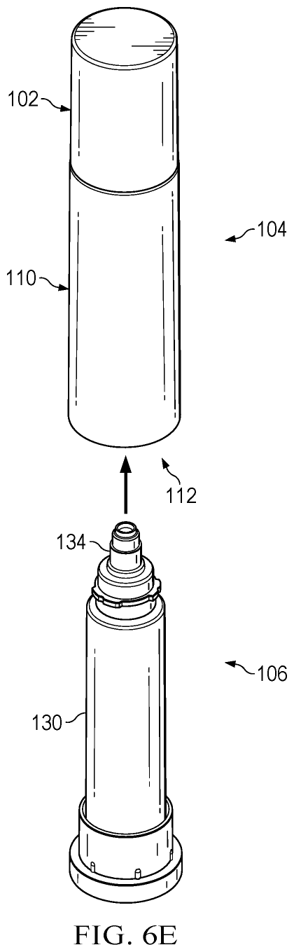

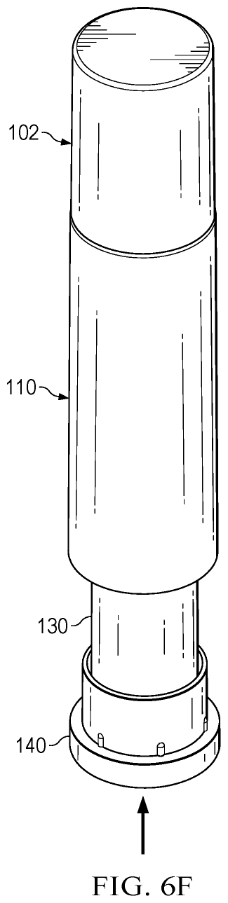

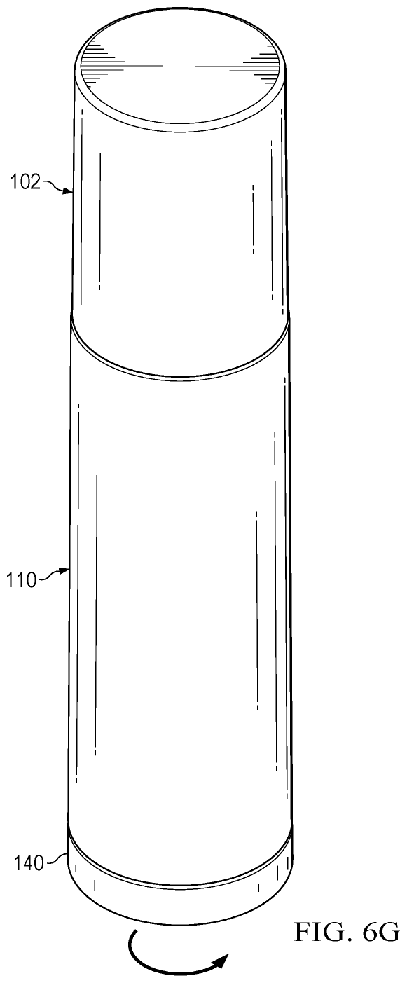

FIG. 1B is an assembled view of the FIG. 1A package 100. As shown by the vertical alignment in FIG. 1A, the inner bottle assembly 106 fits concentrically within the interior of the outer bottle assembly 104, with further cooperation of certain pieces of those assemblies as detailed later. Further, the fitment of the inner bottle assembly 106 into the interior of the outer bottle assembly 104 may be, for example, by axially rotating one of the two assemblies (or both concurrently) relative to the other, as further shown later in FIGS. 6A-6G. After the inner and outer bottle assemblies 106 and 104, respectively, are so fitted together, product within the inner bottle assembly 106 may be dispensed by operating an actuator 108 of the outer bottle assembly 104, for example when a user holds the assemblies and uses a finger(s) to depress the actuator 108. Thereafter, for example when some or all cosmetic product has been dispensed from the inner bottle assembly 106, a user can remove the inner bottle assembly 106 from the outer bottle assembly 104, by reversing the manner in which the two were assembled (e.g., by rotating one or both in the opposite direction than was used to assemble them together). In an example embodiment, the outer bottle assembly 104 may then be recycled (or otherwise disposed of), and a new replacement inner bottle assembly 106, having cosmetic within its interior, may again be fitted to the outer bottle assembly 104, thereby completing the refillable aspect of the package 100. Also as part of the above-described assembly steps, the overcap 102 is fitted to the top of the outer bottle assembly 104, for example by snap fitment, for example for aesthetics and also to avoid incidental operation or pressing of the actuator 108.

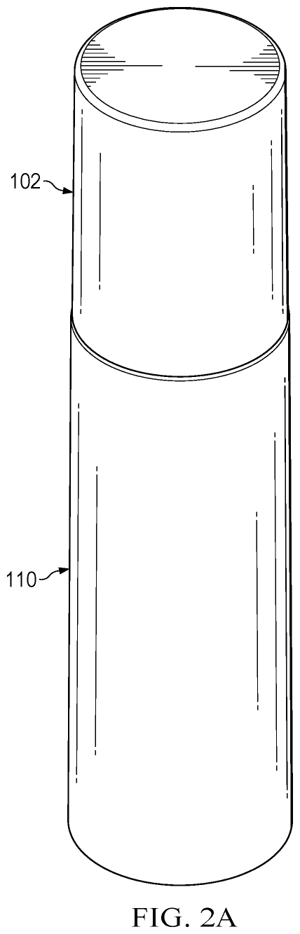

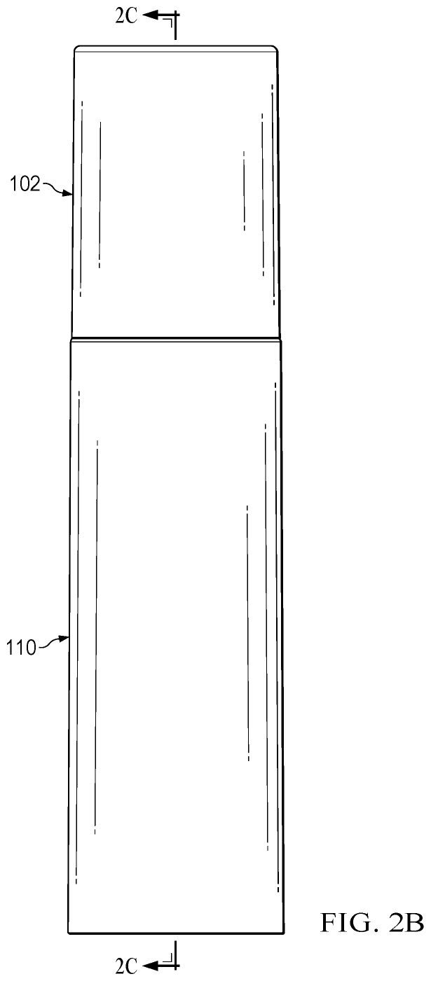

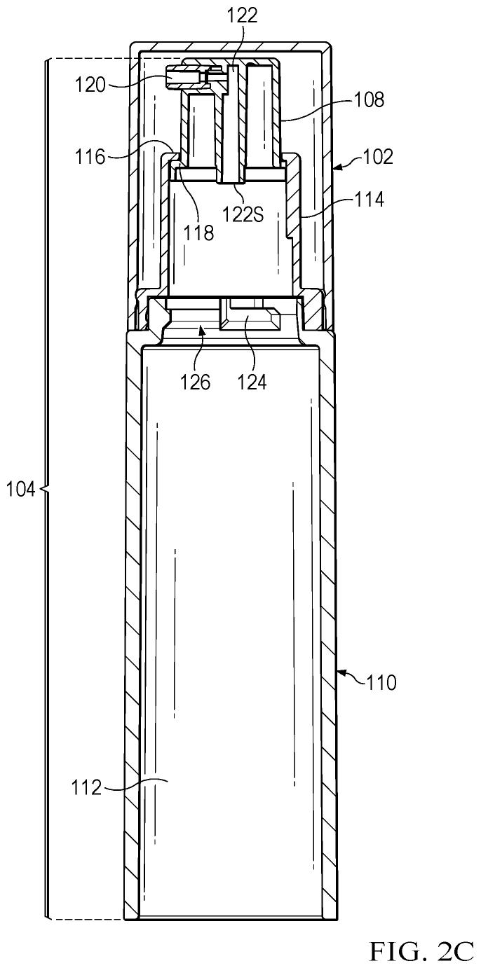

FIGS. 2A-2C illustrate additional detail of the FIGS. 1A-1B outer bottle assembly 104, and again show the overcap 102 connected thereto. In more detail, FIG. 2A illustrates the outer bottle assembly 104 and the overcap 102 in perspective view, FIG. 2B in side view, and FIG. 2C in cross-sectional view. The outer bottle assembly 104 includes an outer bottle 110, for example having a cylindrical outer shape, which is a volumetric region with a lower open end 112. The open end 112 is for receiving initially an upper end, and then a majority or entirety, of the inner bottle assembly 106. Generally, but not necessarily, the outer bottle 110 has both an outer and inner shape that matches the outer shape of the inner bottle assembly 106; this shape may be cylindrical, or it may have alternative configurations (e.g., parallelogram with a square or rectangular cross-section, or with other cross-sections, such as a triangle, ellipse, or oval). In an example embodiment, the outer bottle 110, either alone or along with other (or all) pieces of the outer bottle assembly 104, may be transparent or translucent, for example to allow a user to see through the device to assist with assembly and also to observe when cosmetics in the inner bottle assembly 106 are depleting or have fully depleted.

The FIG. 2C cross-sectional view illustrates a cooperation of the bottom of the actuator 108 with a shoulder 114. The shoulder 114 may be snap fit or friction fit onto the outer bottle 110, or alternatively attached by screw or other fit. By way of illustration in FIG. 2A (and FIG. 1A), the actuator 108 is shown in its raised position, that is, extended away from the outer bottle 110, as will be achieved when the inner bottle assembly 106 is fitted into the outer bottle assembly 104, as additionally detailed later. Specifically, the shoulder 114 has an inwardly-extending upper annulus 116, that extends inward from an outer diameter of the shoulder 114. Relatedly, a lower portion of the actuator 108 additionally has an outwardly-extending lower annulus 118, that extends outward from the outer diameter of the actuator 108. The diameter of the outwardly-extending lower annulus 118 is larger than the aperture created by the diameter of the inwardly-extending upper annulus 116, so that as the actuator 108 is raised, the inwardly-extending upper annulus 116 acts as a stop when the outwardly-extending lower annulus 118 moves upward and abuts with the inwardly-extending upper annulus 116. Accordingly, the cooperation of these aspects limits the farthest upward movement of the actuator 108. Further, the actuator 108 includes a dispensing tip 120, which fluidly communicates with a passageway 122 that extends axially within the actuator 108. In an example embodiment, the dispensing tip 120 is generally perpendicular to the passageway 122, and the dispensing tip 120 extends a radial distance away from the outer diameter of the actuator 108 that is laterally beyond the inner extent of the inwardly-extending upper annulus 116. Accordingly, when the inner bottle assembly 106 is not positioned within the outer bottle assembly 104, the actuator 108 may slide freely downward within the shoulder 114, but the distal end of the dispensing tip 120 will abut the inwardly-extending upper annulus 116, so each acts as a stop relative to the other, thereby preventing further downward movement of the actuator 108 and preventing it from sliding farther so as to separate from the shoulder 114.

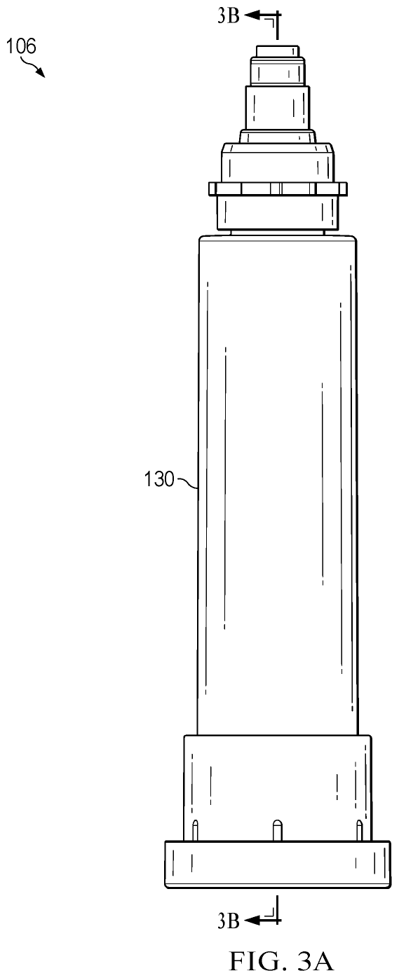

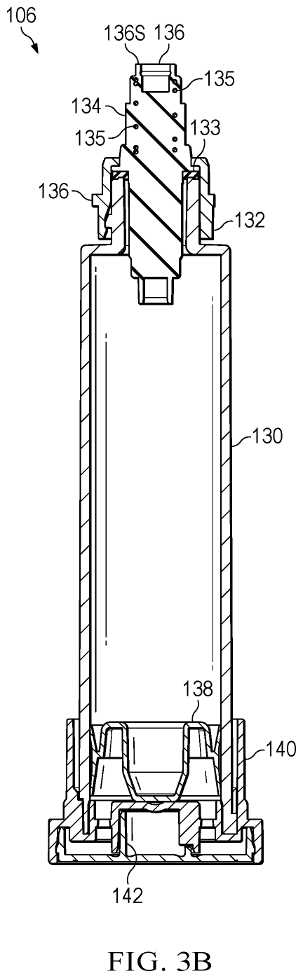

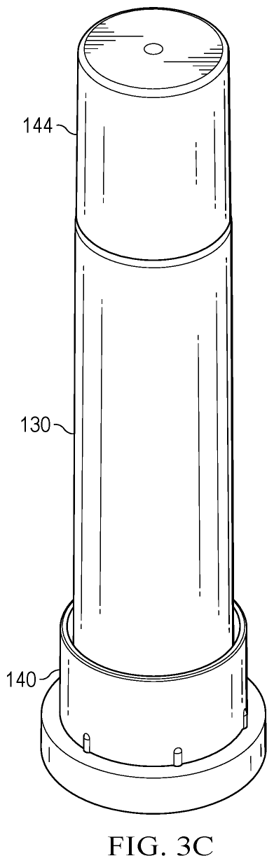

As introduced above, the inner bottle assembly 106 engages with and within the outer bottle assembly 104. In this context, the FIG. 2C cross-sectional view also illustrates that the outer bottle 110 includes a lower-assembly attachment member 124, proximate the interior top of the outer bottle 110. The lower-assembly attachment member 124 may include, for example, a shelf parallel to the bottle 110 cross-section and adjacent a slot 126, whereby a tab (or tabs, shown as tabs 136 in FIG. 3B, below) on the inner bottle assembly 106 passes through the slot 126, and then when the assemblies 104 and 106 are rotated relative to one another, the tab 136 engages with and contacts the upper surface of the shelf, where for example the shelf may include a chamfered edge or the like to direct the tab relative to the shelf's surface. As the tab of the inner bottle assembly 106 engages with the attachment member 124 (e.g., shelf) of the outer bottle assembly 104, in coinciding fashion this affixes the assemblies 104 and 106 to one another.

FIGS. 3A-3B illustrate additional detail of the FIGS. 1A-1B inner bottle assembly 106. In the illustrated example, the inner bottle assembly 106 forms a portion of an airless dispenser; in an alternative example embodiment, it may include apparatus to provide a dip tube dispenser. In more detail of the FIG. 3A example, it illustrates the inner bottle assembly 106 in perspective view, and FIG. 3B in cross-sectional view. The inner bottle assembly 106 includes an inner bottle 130, providing a storage volume in which a liquid cosmetic is stored, for example by the device manufacturer. Toward the top of the inner bottle 130, a collar 132 attaches to the inner bottle 130 and affixes a pump 134 (e.g., spring loaded (spring 135 shown in cutaway) and sealed with a gasket 133) in place relative to both the collar 132 and the inner bottle 130. The collar 132 also includes the above-described tab (or tabs) 136, which extend radially outward from the collar 132 and physically cooperate (e.g., abut) with the inner-assembly attachment member 124. The pump 134 may be of various types, for example to accommodate either airless or dip tube operation. The pump 134 includes an upper aperture 136, which fluidly communicates with the lower portion of the passageway 122 in the actuator 108 (see FIG. 2C). For example, the upper aperture 136 has a physical surround 136S which may physically abut with a surround 122S of the lower portion of the passageway 122, so that when the actuator 108 is pushed downward, the two surrounds 122S and 136S are touching, and movement of the actuator 108 downward causes a coinciding downward movement of the pump 134; in response, cosmetic is drawn from the inner bottle 130, up through the pump 134 and out its upper aperture 136, and into the lower portion of the passageway 122. The cosmetic can then continue to flow through the entirety of the passageway 122 and out the dispensing tip 120. Further in regard to cosmetic movement, for the example of an airless dispenser, FIG. 3B also illustrates a piston 138, which after cosmetic is located within the inner bottle 130, is initially toward the bottom of the inner bottle 130. Thereafter, as the pump 134 is operated, the piston 138 is drawn toward the pump 134 (e.g., upward), so as to increase the pressure within the inner bottle 130 and thereby dispel cosmetic toward and through the pump 134.

FIGS. 3A-3B also illustrate additional apparatus that may be associated with or near the bottom of the inner bottle 130, namely, a base 140 and a base plug 142, where the separateness of the base plug 142 may be desirable for weight and/or molding considerations. The base 140 can provide structural standing support for the inner bottle assembly 106 when it is separated from the outer bottle assembly 104, or for the combination of both the outer and inner bottle assemblies 104 and 106 when the two are coupled to each other. In an example embodiment, the bottom circumference of the inner bottle 130 has an outer diameter near the inner diameter of the top of the base 140, and additional tabs or the like may be used for either a snap fit or rotationally fit alignment of the inner bottle 130 to the base 140.

FIG. 3C illustrates the FIGS. 3A-3B inner bottle assembly 106 with a temporary and optional service cap 144 attached to its collar 132 (see FIG. 3B), and in an example embodiment the service cap 144 also may be formed from recyclable PP. For example, when a consumer purchases/receives replaceable refills, they may be shipped and received in the FIG. 3C form, so that the service cap 144 further protects the pump 134 and collar 132 during shipping.

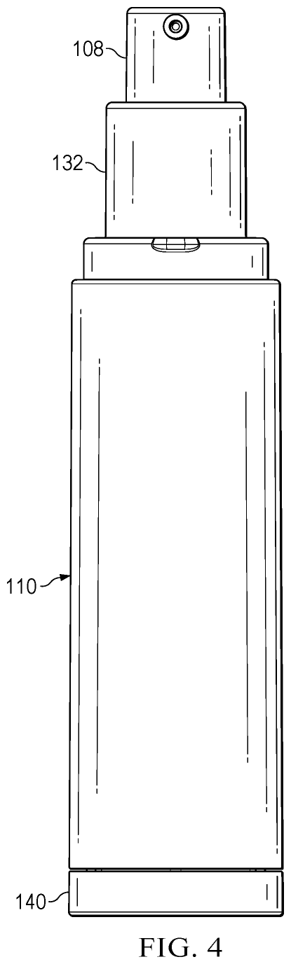

FIG. 4 illustrates a perspective view of the inner bottle assembly 106 when coupled to the outer bottle assembly 104.

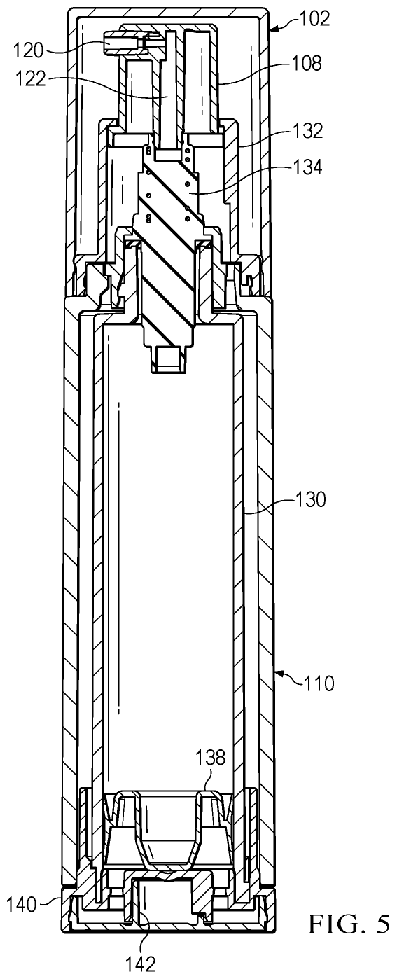

FIG. 5 illustrates an axially cross sectional view of FIG. 1B.

FIGS. 6A-6C illustrate the disassembly steps of removing the outer bottle assembly 104 from the inner bottle assembly 106. In FIG. 6A, the two assemblies 104 and 106 are connected together, and the overcap 102 is atop the actuator (not shown in the FIG. 6A). An arrow near the bottom of FIG. 6A indicates that by rotating the inner bottle assembly 106 in a counterclockwise direction (e.g., by turning its base 140), relative to the outer bottle assembly 104, the two separate and the inner bottle assembly 106 may be pulled (or dropped) downward from the bottom of the outer bottle assembly 104. FIG. 6C illustrates the further dropping of the inner bottle assembly 106, that is, the removing of the two assemblies from one another, where it may be seen that the inner bottle assembly 106, including its pump 134, separates from the outer bottle assembly 104 and its actuator 108 (see FIG. 2C), which remains under the overcap 102. In this manner, a customer may remove the inner bottle assembly 106, for example when the cosmetic stored in it is partially or fully depleted, or if there is a different cosmetic available in a different inner bottle assembly 106, so as to switch to have access to being able to dispense that different cosmetic.

FIGS. 6D-6G illustrate the assembly steps of attaching the outer bottle assembly 104 to the inner bottle assembly 106, for example in reverse fashion relative to FIGS. 6A-6C. For example, FIG. 6D illustrates the inner bottle assembly 106, with its service cap 144 attached thereto, and supported vertically by its base 140. In FIG. 6E, the service cap 144 is removed, and the inner bottle assembly 106 is aligned axially relative to, and beneath the open end 112 at the bottom of the outer bottle assembly 104. In FIG. 6E, while maintaining the FIG. 6D axial orientation, the outer and inner bottle assemblies 104 and 106 are brought together, until the two can no longer move axially relative to one another; as shown in FIG. 5, and at this point the top of the pump 134 abuts the bottom of the passageway 122. In FIG. 6F, the inner bottle assembly 106 is rotated about its axis, as shown by an arrow in the clockwise direction, thereby affixing the two assemblies 104 and 106 together, for example by rotating the tabs 136 (see FIG. 3B) of the inner bottle assembly 106 to the lower-assembly attachment member 124 of the outer bottle assembly 104 (see FIG. 2C).

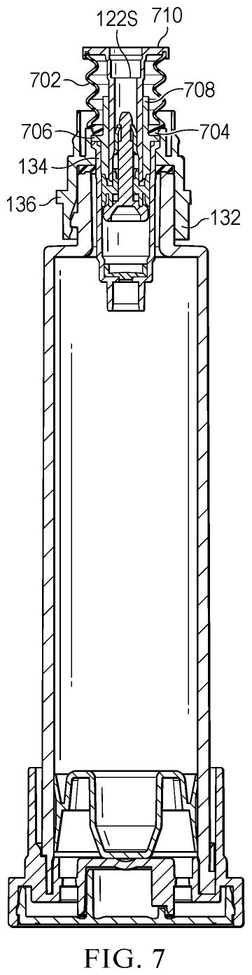

FIG. 7 illustrates an alternative example of the FIGS. 1A-1B inner bottle assembly 106 in cross-sectional view, in which is a bellow spring 702 is incorporated into the pump 134. In an example, the bellow spring 702 is constructed of a flexible material, which also may be recyclable, and is shaped in a bellow fashion, that is, to have panels that fold back and forth in a continuous fashion, so that the device may collapse to bring opposing panels closer to one another or may expand to move them farther apart (in an angular sense at the joint between the two panels, and an absolute sense at the distance away from the joint). Accordingly, in general the FIG. 7 structure includes many of the same apparatus as FIG. 3B, although the spring 135 is eliminated, and the bellow spring 702 is external from, for example axially aligned with but having an inner diameter greater than, the outer structure and diameter of the pump 134. The bottom 704 of the bellow spring 702 abuts an outwardly extending flange 706 on a pump collar 708. The top 708 of the bellow spring 702 abuts a disc 710 which has a central aperture through which the surround 122S of the lower portion of the passageway 122 fits so as to cooperate with the top of the pump 134, and its fluid path, when the inner bottle assembly 106 is brought upward to couple inside the outer bottle assembly 104. Once this coupling is achieved, the actuator 108 may be depressed as against the force of, and to compress, the bellow spring 702, which once the actuator 108 is released, the bellow spring 702 will provide an opposing force, moving the actuator 108 away from the pump 134.

Given the above-described physical, material, and cooperative relationships, the package 100 may include any one or more of numerous features. For example, the package 100 provides a refillable pump portion in the form of the inner bottle assembly 106, which allows easy consumer operation/replacement, and that attaches to an outer bottle assembly 104. Further, the general replacement step involves two parts (assemblies 104 and 106), not requiring a pulling part of an original package or more than two parts, as may be the case with other disassembling packages. Still further, both the refill inner bottle assembly 106 and outer bottle assembly 104 are of the appropriate design and materials to allow for recycling. As another example, the inner bottle assembly 106 can be comprised of either a dip tube atmospheric pump or airless pump. The outer bottle assembly 104, which is reused, is comprised of a bottle, collar and actuator, and an optional cap that attaches to the new inner bottle refill. The inner bottle assembly 106 may be comprised of like materials for example PP, or others such as HDPE or other recyclable materials to be able to be effectively recycled in municipal recycling streams, also having appropriate materials and physical size. Likewise, the outer bottle assembly 104 can be comprised of materials for example PET, or others such as HDPE, PP, ABS, or other like recycled materials to be able to be recycled in municipal recycling stream due to material selected and requisite size, as these containers reach end of life. The package 100 also facilitates a quick turn screw or snap mechanisms or other attachment mechanisms, to allow for easy removal of the inner bottle assembly 106 from the outer bottle assembly 104 and for secure refill replacement. Further, with each refill replacement of the inner bottle assembly 106, the refill provides a new pump 134, to allow hermetic assembly to the outer bottle assembly 104, aiding in safety, cleanliness, and hygiene for the consumer, as well as reducing the possible failure rate that could be incurred with a reusable pump. Accordingly, one skilled in the art should understand and appreciate that embodiments provide a cosmetic package that may include various features and described embodiments improve the state of the art. Further, while the inventive scope has been demonstrated in various aspects of embodiments, still other variations are contemplated or will be ascertainable by one skilled in the art, with the hindsight of the inventive teachings herein. Accordingly, while features have been described to serve to illustrate the inventive scope as have been demonstrated by certain embodiments, one skilled in the art will appreciate that the scope is further subject to various modifications, substitutions, or alterations, without departing from that inventive scope. Still other examples will be ascertainable by one skilled in the art given the teachings herein and as further guided by the following exemplary but non-exhaustive claims.

What is claimed is:

1. A cosmetic apparatus, comprising:
a first member comprising:
a body;
an actuator at a first end of the body; and
an aperture at a second end of the body, distal from the first end; and
a second member comprising:
a pump;
a storage volume, the storage volume configured to store cosmetic; and
an engaging member for fitting the second member at least partially through the aperture and at least partially within the body.

2. The cosmetic apparatus of claim 1 wherein the first member comprises polyethylene terephthalate.

3. The cosmetic apparatus of claim 1 wherein the second member comprises polypropylene.

4. The cosmetic apparatus of claim 1 wherein the first member comprises a transparent material.

5. The cosmetic apparatus of claim 1 wherein the pump comprises an airless pump.

6. The cosmetic apparatus of claim 5 and further comprising a piston within the storage volume.

7. The cosmetic apparatus of claim 1 wherein the pump comprises a dip tube pump.

8. The cosmetic apparatus of claim 1:
wherein the engaging member comprises a first engaging member; and
wherein the first member further comprises a second engaging member for engaging the first engaging member so as to affix the first member and the second member in a fixed relation to one another.

9. The cosmetic apparatus of claim 8 wherein the second engaging member comprises a shelf and the first engaging member comprises at least one tab.

10. The cosmetic apparatus of claim 8 wherein the first engaging member is for engaging with the second engaging member by rotation of the first member relative to the second member.

11. The cosmetic apparatus of claim 8 wherein the first engaging member is for engaging with the second engaging member by rotation of the first member axially relative to the second member.

12. The cosmetic apparatus of claim 1 wherein the first member further comprises:
a dispensing tip coupled to the actuator; and
a collar for slidably receiving the actuator; and
wherein the dispensing tip engages the collar when the second member is disconnected from the first member.

13. The cosmetic apparatus of claim 1 wherein the storage volume includes cosmetic.

14. The cosmetic apparatus of claim 1 wherein the engaging member is further for coupling a fluid path of the actuator with a fluid path of the pump when the second member is at least partially fit through the aperture.

15. The cosmetic apparatus of claim 1 wherein the second member includes a spring for applying a bias force against the actuator.

16. The cosmetic apparatus of claim 15 wherein the spring is within a material of the pump.

17. The cosmetic apparatus of claim 15 wherein the spring is external from the pump.

18. The cosmetic apparatus of claim 15 wherein the spring comprises a bellow spring.

19. A method of providing a cosmetic apparatus, comprising:
positioning a first member, the first member comprising a body, an actuator at the first end of the body, and an aperture at a second end of the body, distal from the first end; and
coupling a second member to the first member by inserting an end of the second member at least partially within the body, the second member comprising a pump, a storage volume configured to store cosmetic, and an engaging member for fitting the second member at least partially through the aperture and at least partially within the body.

20. The method of claim 19 and further including removing the second member from coupling to the first member.
